(19) United States
(12) Patent Application Publication
(10) Pub. No.: US 2005/0044498 A1
(43) Pub. Date: Feb. 24, 2005

(54) Computerized printing system, procedures to control such systems and the appropriate software products

(75) Inventors: Albin Stoderschnig, Munchen (DE); Steffen Petz, Poing (DE)

Correspondence Address: SCHIFF HARDIN LLP;Patent Department, 6600 Sears Tower, 233 South Wacker Drive, Chicago, IL, 60606, US

(73) Assignee: Oce Printing Systems GmbH

(21) Appl. No.: 10/919,957

(22) Filed: Aug. 17, 2004

(30) Foreign Application Priority Data
Aug. 18, 2003 (DE) 103 37 837.5

(51) Int. Cl. G06K 1/00

(52) U.S. Cl. 715/700; 358/1.15

(57) ABSTRACT

The invention concerns a computerized printing system with a printer and print server clients that are connected via a data network. The print servers have a graphical user interface from which several application programs may be operated. The printing system comprises one or several data units which are called workspaces. A frame of the graphical user interface is assigned to each of these workspaces. Each data unit has a list which includes one or several application programs. It also includes a configuration data file in which these application programs are assigned to precisely one window within the frame of the graphical user interface. Consequently, the user is provided with a set graphical user interface with a user-friendly display of the application programs. An appertaining method and software product are also provided.

### BACKGROUND OF THE INVENTION

The invention concerns a computerized printing system, particularly a computerized printing system with a data processor which is connected at least to one printer for the purpose of displaying a graphical user interface for a comprehensive program system including a variety of application programs.

Under the trade name Oce PRISMA production®, the applicant offers a program system that comprises various application program modules. This program system is able to control the production load of one or several printers. A description of this program system is included in Chapter 11 of Das Druckerbuch, Technik und Technoligien der OPS-Hochleistungsdrucker, published by Dr. Gerd Goldmann, edition 5a, October 2000, ISBN 3-00-001019-X.

In order to operate the various application programs of Prismapro, a user interface has been provided which is called Prisma Explorer (FIG. 9). This user interface has two windows which are divided via a vertical separation bar. To the left of the separation bar, in a tree structure, the names of the application programs are shown. To the right of the separation bar, the data of the various application programs is displayed. In this regard, it is only possible to display the data of one particular application program. For each activated program, a tab will appear at the upper edge of the window. By clicking on one of the tabs, the corresponding data will be displayed.

German patent document DE 101 22 880 A1 involves a system in which commands regarding the printed end product are prepared and sent to a processing station. This system has a monitor which provides a graphical user interface (GUI). For this purpose, the possibility of controlling the workflow-function has to be integrated into one single interface. At this graphical user interface, documents, tickets, and other components and applications are visually displayed, for instance, via icons, tree structures, and pull-down menus. It is possible to control these interactively using known devices and procedures, such as a mouse or other trackball. For the development of a graphical user interface, software development packages are offered as, for instance, the Microsoft “Open Software Development Kit.”

German patent document DE 691 32 229 T2 (corresponding to European patent document EP 0 818 724 B1) involves another printing system with a graphical user interface. The “IBM Infoprint Manager for Windows [online],” which is available through the Internet address (on Aug. 9, 2004): http://publib.boulder.ibm.com/prsys/pdfs/5445475e.pdf, (update at ftp://ftp.software.ibm.com/printers/specs/win21rme.pdf) offers a printing system with which printing jobs can be distributed via the Internet. Via this printing system, the printing jobs can be organized and monitored. This printing system also has a graphical user interface.

Computerized printing systems with such user interfaces, in which an operator controls central printing operations simultaneously at several printers, have proved to be useful tools. These operators are equipped with specific expertise.

Since, however, the printing systems are increasingly networked and developed nationwide, it is required that the printing operation can also be controlled locally. It is not always necessary to employ highly qualified personnel.

### SUMMARY OF THE INVENTION

Therefore, the invention has the objective of providing an easy to use computerized printing system.

This objective is achieved by a computerized printing system, comprising: at least one printer; a plurality of application programs; a graphical user interface comprising an input configured for entering information into the plurality of application programs, the user interface comprising one or more frames, at least one of the frames comprising a window to which one of the application programs is assigned such that each application program is assigned to one particular window; a data processor which is connected to the at least one printer and configured to provide a display on the graphical user interface and is further configured to run the plurality of application programs; and one or more workspaces which are date units, each of which has assigned to it one of the frames, each workspace including a reference to one or more of the plurality of application programs, wherein immediately after accessing each workspace, the system is configured to display on the graphical user interface a window for accessing an activation function configured to activate all application programs of a particular workspace.

This object is also achieved by a method for operating a computerized printing system with a data processor which is connected at least to one printer, comprising: providing a variety of application programs for the system; accessing a data unit which is a workspace; opening a frame in a graphical user interface of the system; accessing all application programs referenced by the workspace; and assigning these application programs to a particular window in the frame of the graphical user interface.

Various embodiments of the invention are discussed in the following. The computerized printing system has a data processor which is connected at least to one printer for the purpose of displaying a graphical user interface for a comprehensive program system including a variety of application programs. Via the user interface, it is possible to make entries into several application programs. The computerized printing system is characterized by one or several data units which are called “workspaces”. A frame of the graphical user interface is assigned to each of these workspaces. Each workspace includes a reference to one or several application programs. Each application program, in turn, is assigned to one particular window within the frame of the graphical user interface. Immediately after accessing each workspace, a function to activate all application programs of a particular workspace appears.

The computerized printing system is designed in a way that the workspaces have a function to deactivate all application programs of a workspace as soon as the particular workspace is closed.

The inventive workspaces always make reference to a particular application program, and for each application program, a window is provided within the frame of the graphical user interface. Therefore, selecting a specific workspace predetermines the application programs. At the same time, they can also be displayed on the user interface. Upon accessing the different workspaces, the application programs are opened and closed again when a particular workspace is closed.

The idea is that usually an operator will only use a few application programs which are part of his field of activity, or which are required for a particular workflow. Based on the inventive workspace, these application programs are combined as one unit. At the same time, they are displayed on the graphical user interface. A system administrator is able to create one or several workspaces for each operator which are adapted to the needs and capabilities of that particular operator.

It is possible to start the different application programs automatically upon opening a particular workspace and to close them automatically upon closing a particular workspace. In this way errors are avoided which could result from incorrect processes performed by the operator. In particular, this guarantees that all programs necessary for performing a specific function on the printing system will be opened. In this way, errors are avoided which could be caused if a particular application program depended on another application program but this application program is not activated.

The system administrator could also create for each operator a user-friendly interface. Consequently, it would not be necessary for the operator to start, activate, or deactivate application programs or perform other actions since these functions would be carried out automatically when the workspace is opened and closed. This makes the operation of the complete system considerably easier. As a result, the operator is able to concentrate fully on his job, that of performing specific printing operations.

Embodiments of the inventive computerized printing system could also be designed to have several workspaces. Depending on the field of activity of the operator or the workflows of the operator, it could include a variety of application programs.

In one specific model of the invention, the workspaces are equipped with a function which activates all application programs of the workspace when the workspace is initially accessed. The operator is only able to shut down the individual activated programs by closing the workspace. It is not possible to shut down an individual program. This eliminates the possibility of a handling error.

If possible, the rights of an operator should be defined with regard to accessing the workspace or operating the various application programs within the workspace. There are two possibilities to accomplish this. On the one hand, rights could be assigned to the workspaces within the operating system of the printing system and to the users. For this purpose, the users will only be able to access specific workspaces if their rights correspond to a particular workspace. On the other hand, it is possible to control the operational availability of the workspace and/or the possibility to activate the various application programs by requesting personal user identification.

### DESCRIPTION OF THE DRAWINGS

A detailed description of the embodiments of the invention is found in the following figures and appertaining descriptive text.

FIG. 1 is a block diagram of an embodiment of a printing system;

FIG. 2 is a block diagram illustrating various important elements of the data structure of a printing system;

FIGS. 3 to 8 are various screen displays of the graphical user interface of a computerized printing system; and

FIG. 9 is a screen display illustrating a known graphical user interface.

### DETAILED DESCRIPTION OF THE PREFERRED EMBODIMENTS

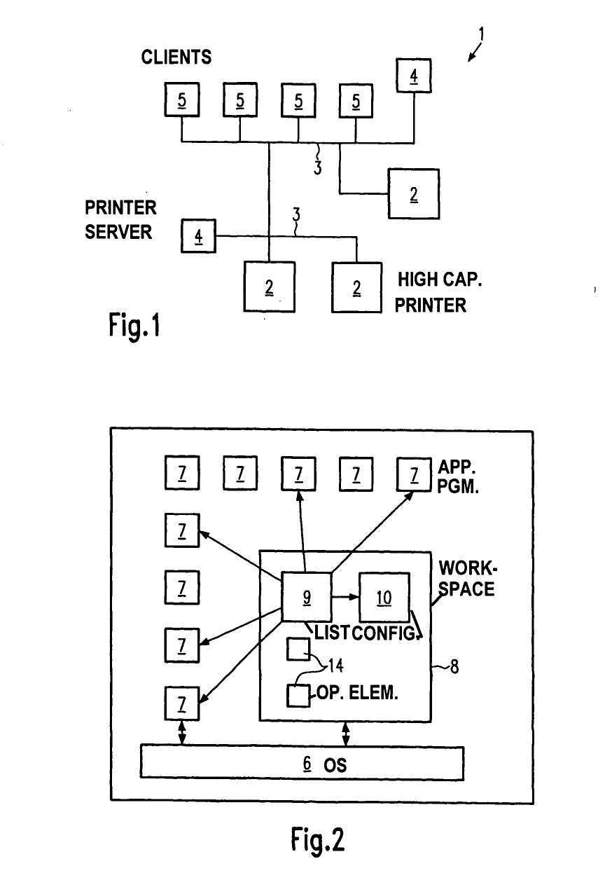

FIG. 1 shows a block diagram of a computerized printing system 1. The computerized printing system 1 comprises several high-capacity printers 2 that are connected via a data network 3 with printer servers 4 and clients 5. At the clients 5, the data to be printed is produced and sent to the printers 2 via the data network 3. However, the data to be printed is not directly sent to the printers 2. It is first received by one of the print servers 4, prepared for the printer 2, and sent to one of the printers 2.

In the data network 3, the printing data are transmitted in the form of a printing data stream which are, for instance, formatted as IPDS (Intelligent Printer Data Stream), PCL (Page Command Language), or PS (PostScript). At the print servers 4, the printing-data streams are directed to the printers 2 and prepared for each individual printer. At each print server 4, an operator is able to access the printing data stream for processing. Each print server 4 has a monitor with a graphical user interface via which the operator is able to operate various application programs. These application programs are part of a program system which, in the embodiment at hand, is distributed under the trade name Prismapro.

FIG. 2 provides a graphical description of a part of the data structure of the print server 4. This data structure includes an operating system 6, such as, Linux or Windows XP, and several application programs 7. Typical application programs include those that monitor printer-queues, process printing jobs, display messages appearing at the printing process, managing the operators who are allowed to operate the printers, and backing up and restoring the printing systems. The data structure of the print servers 4 also has a data unit 8 which is subsequently referred to as a workspace 8. In the embodiment at hand, this workspace 8 comprises a data file in the XML (Extensible Markup Language) format.

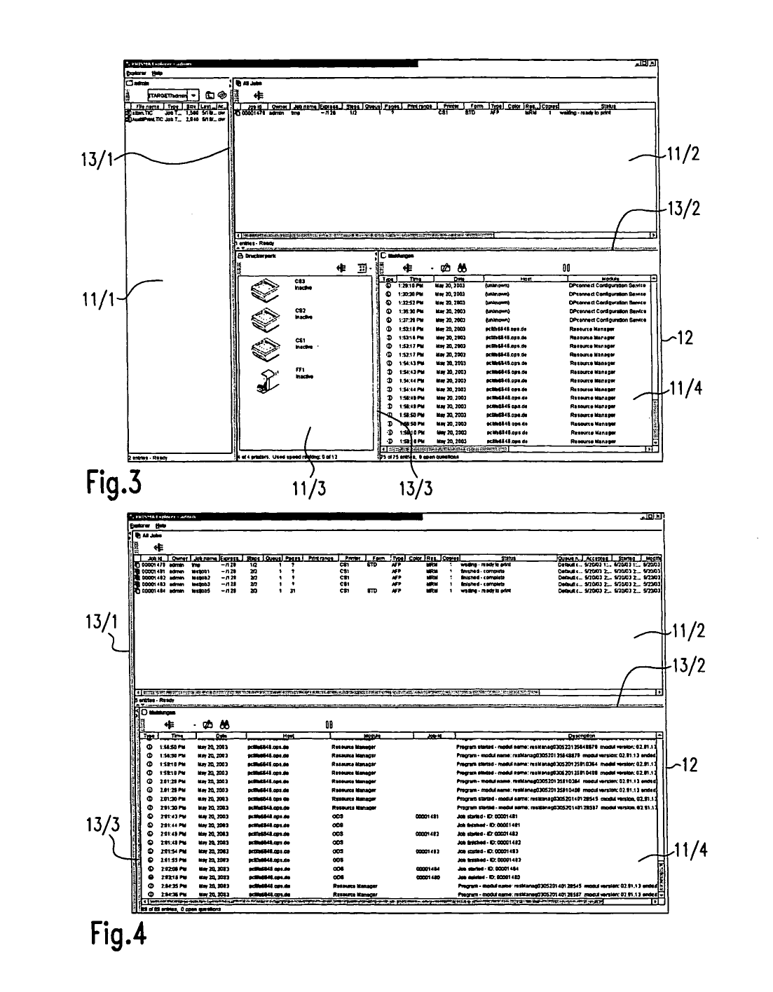

The workspace 8 has a list 9 which refers to part of the application program 7. This workspace 8 includes a configuration data file 10 via which the arrangement of windows 11 (FIG. 3-6) within a frame 12 is defined. The frame 12 with the included windows 11 forms the graphical user interface which is displayed on the monitor of the print server 4.

The configuration data file 10 includes an attachment of the application programs 7 for the windows included in the list 9. Each application program 7 is assigned to and displayed in one particular window 11. The various windows are separated with separation bars 13. In the embodiment described in FIGS. 3 to 5, all separation bars 13 have the same width. However, in the context of the invention, it is also possible to adjust the width of the separation bars 13, particularly if application programs have to be arranged with different levels or priorities.

The user is also able to hide each window 11. Even the size of the window 11 can be adjusted. However, in this particular embodiment, the user is not able to adjust the arrangement of the window 11 or the separation bar 13. This means that a particular window 11 will always be arranged above or beneath, and to the right or to the left of a particular separation bar 13 or other window 11, provided both windows are activated. In this way, the user will always have the same screen layout.

The configuration data file 10 is made in a way that all application programs 7 referred to by the list 9 are activated as soon as the workspace 8 is accessed. The activating of the application programs 7 includes the process of starting, activating or performing other steps required for starting an application program 7. The closing of the workspace also closes all application programs 7. If possible, the individual user should not be able to deactivate the different application programs 7. This guarantees that the application programs 7 required for the performance of a specific function are all enabled at the same time. It also prevents errors from occurring during the operation of the printing system 1.

The workspace 8 could also include other operational elements 14. For instance, it could include an operational element 14 which, during the uploading process of the workspace 8, controls the user identification included in the operating system 6. Via this user identification, the user will be identified. Depending on the user identification, it would be possible to gather information regarding the user rights for operating a particular application program 7. These rights will be prerecorded either in the workspace 8 or in the operating system 6. However, these rights could also be prerecorded in the operating system 6 via which the user could then be granted his specific rights. In case there are several workspaces, the verification of the user identification within the operating system 6 has the advantage that a particular user will only be allowed to access those workspaces 8 for which he has been granted the rights.

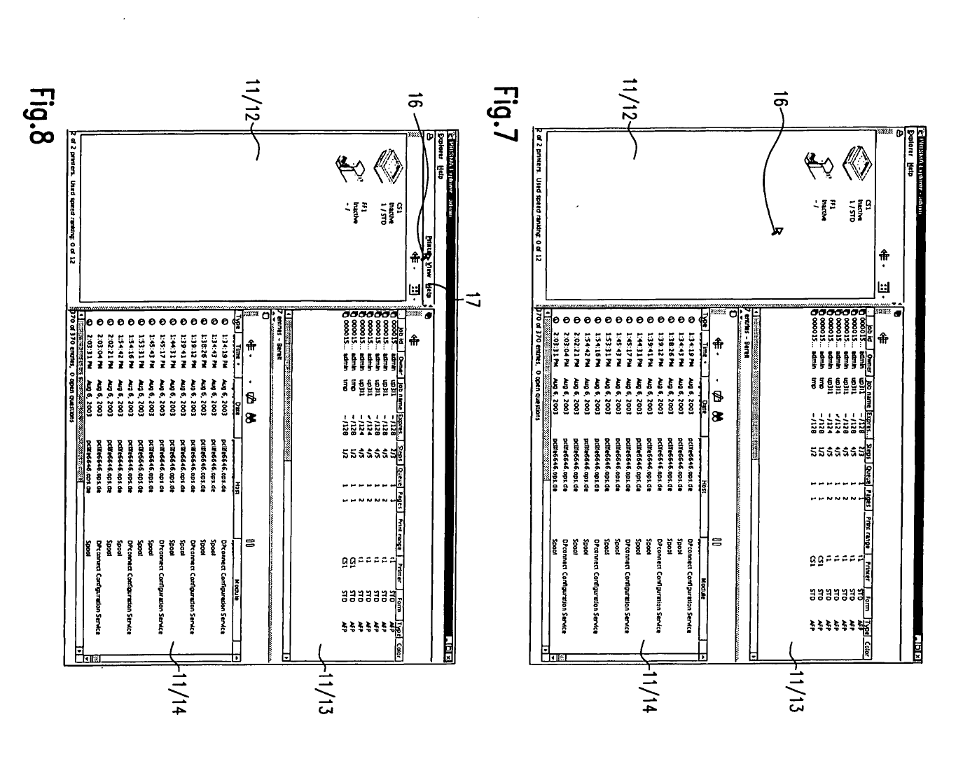

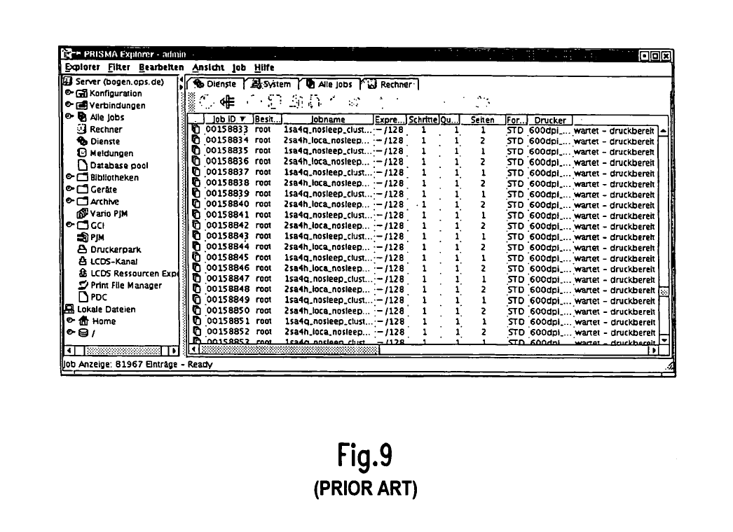

Another operational element 14 could be made in a way that, in the different windows 11 of the application programs 7, a menu line is only displayed if a mouse pointer 16 is placed in the area of the menu line 17. The embodiment shown in FIGS. 7 and 8 provides three windows 11/12, 11/13, and 11/14, whereupon the mouse pointer 16 in FIG. 4 is placed in window 11/12. In FIG. 8, the mouse pointer 16 is placed in the area of the menu line 17 of the window 11/12. Therefore, this menu line displays the menu item “Printer View Help.” In this way, the graphical user interface is not overloaded with menu lines. The menu lines only appear on the screen if they are required.

In a different model according to an embodiment of the invention, the icons for accessing specific functions of the application programs of joining windows are placed adjacent to the shared separation bar, resulting in a shared area of icons (not displayed).

FIGS. 3 to 5 each show the graphical user interface of an embodiment with four windows 11/1, 11/2, 11/3, and 11/4, which are separated by three separation bars 13/1, 13/2, and 13/3. In window 11/1, an application program is activated, displaying a directory. The window displays the directory “admin.” Window 11/2 shows a list of all printing jobs. Window 11/3 shows the available printers represented by their respective icons. By clicking on the icons, the user is able to activate a specific printer function. Window 11/4 lists all messages resulting from a printing operation.

In FIG. 4, windows 11/1 and 11/3 are hidden, and windows 11/2 and 11/4 are extended over the total width of the frame.

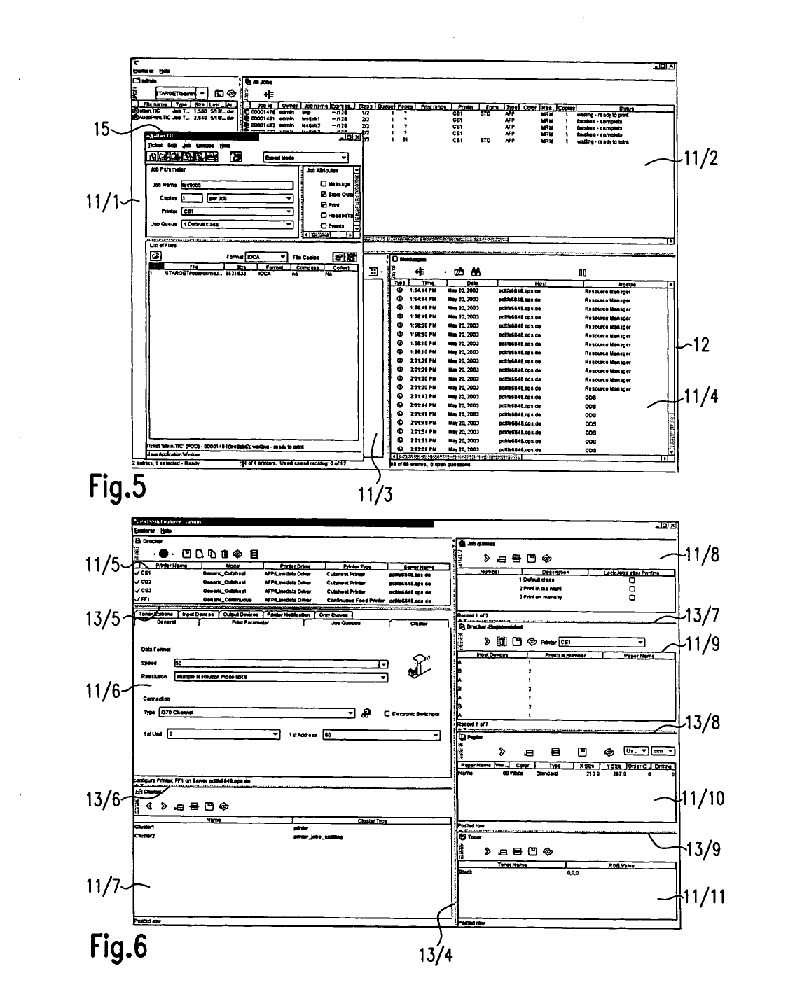

FIG. 5 generally shows the same window arrangement as FIG. 3. In window 11/2, one of the printing jobs has been clicked on. As a result, another frame 15 has been opened, displaying the properties of this particular printing job. If necessary, the user is able to adjust the properties. For instance, in this frame 15, the user is able to adjust the number of copies to be printed. In addition to the 1½ printing jobs displayed in the window, FIG. 5 also shows the active state of the printing, as, for instance, waiting—ready to print, or finished—complete. This means that, in the workspace, it is possible to display the active return values of the activated application programs and to update them.

FIG. 6 shows an embodiment with seven windows, 11/5 to 11/11. These windows are separated by six separation bars, 13/4 to 13/9. The separation bars 13/6, 13/7, and 13/9 are smaller than the separation bars 13/4, 13/5, and 13/8. This indicates that the windows adjacent to a small separation bar include closely linked application programs. The workspace of FIG. 6 has been designed for a user who is authorized to set up printers. Consequently, the user is able to determine the paper as well as the toner for different printers. Such functions are also included in the adjacent windows 11/10 and 11/11. Therefore, these two windows are separated by a small separation bar.

In the above-mentioned embodiment of the invention, the printer server 4is connected to only one workspace 4. The invention provides, of course, the possibility of assigning several workspaces 8 to a printer server 4. Any authorized user has access to these workspaces 8 but is not able to adjust the workspaces 8. However, the manufacturer of these computerized printing systems is able to set up the workspaces 8 according to the requirements of his customers. This also includes appropriate software which supports the manufacturer of the printing systems in customizing the workspaces 8.

In the above-mentioned embodiment, the workspaces 8 comprise XML data files which are saved and run on the various printer servers 4. It is possible to operate the software which includes the XML data files via a machine-readable data carrier. The XML data files interact with the application programs 4 and/or the operating system 6. Based on various embodiments of the invention, it is also possible that a software product creates workspaces 8 via control information or data units other than XML data files.

The embodiment could be summarized as concerning a computerized printing system with a printer and print server clients that are connected via a data network. The print servers have a graphical user interface from which several application programs could be operated. The printing system is characterized by one or several data units which could be called workspaces. Each of these workspaces is assigned to a frame of the graphical user interface. Each data unit has a list which includes one or several application programs. It also includes a configuration data file in which these application programs are assigned to precisely one window within the frame of the graphical user interface. Consequently, the user is provided with a set graphical user interface with a user-friendly display of the application programs.

In the above-mentioned embodiment, mainly one printing system is described. However, obviously the invention also includes appropriate program executions and software products. Therefore, it is possible to transfer system-related features to data-flow- and software-related features and vice versa.

The embodiment described above indicates that the print server operates with only one workspace. However, the print server could even include several workspaces. In the process of uploading the programming system, each workspace could be selected either by an operator or automatically, in particular, controlled by way of the user identification of the operator. By way of this user identification, the operator's user rights for activating the application programs could be automatically implemented.

Embodiments of the invention could be particularly provided as software programs. Such programs could be distributed in the form of a software module as data file on a data carrier, such as a disk or CD-ROM, or as data file via a data or communication network. Various models of the invention comprise these and similar software products or software elements. The invention-based procedure could be used in a computer, printer, or printing system with upstream or downstream data processing devices. The computers in which the invention will be used may include input devices (keyboard, mouse, touch screen), a microprocessor, data bus, or bus control, a displaying device (monitor, display), as well as working memory, fixed-disk storage, and a network interface card.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

Reference Characters

1 Computerized printing system
2 High-capacity printer
3 Data network
4 Printer server
5 Clients
6 Operating system
7 Application program
8 Workspace
9 List
10 Configuration data file
11 Window
12 Frame
13 Separation bar
14 Operational element
15 Frame
16 Mouse pointer
17 Menu line

1. A computerized printing system, comprising:
at least one printer;
a plurality of application programs;
a graphical user interface comprising an input configured for entering information into the plurality of application programs, the user interface comprising one or more frames, at least one of the frames comprising a window to which one of the application programs is assigned such that each application program is assigned to one particular window;
a data processor which is connected to the at least one printer and configured to provide a display on the graphical user interface and is further configured to run the plurality of application programs; and
one or more workspaces which are date units, each of which has assigned to it one of the frames, each workspace including a reference to one or more of the plurality of application programs, wherein immediately after accessing each workspace, the system is configured to display on the graphical user interface a window for accessing an activation function configured to activate all application programs of a particular workspace.

2. The computerized printing system according to claim 1, wherein the one or more workspaces comprise a deactivation function configured to deactivate all application programs of a workspace as soon as this particular workspace is closed.

3. The computerized printing system according to claim 2, wherein the activation function is configured to not permit activation of different application programs separately, and the deactivation function is configured to not permit deactivation of different application programs separately.

4. The computerized printing system according to claim 1, further comprising:
user rights associated with a user that are assigned to each workspace configured to permit the user to access only a specific workspace to which the user possesses the appropriate rights.

5. The computerized printing system according to claim 1, wherein the data processor further comprises an operating system configured to provide access to specific workspaces that can only be accessed with a particular user identification.

6. The computerized printing system according to claim 5, wherein the workspaces comprise a user identification verification function configured to verify the user identification, the user identification determining which of the application programs the verified user is permitted to activate.

7. The computerized printing system according to claim 1, wherein a frame of a particular workspace includes windows only for application programs for which a specific reference is made in the particular workspace.

8. The computerized printing system according to claim 1, wherein the windows of the application programs within the frames are arranged according to a set and unchangeable configuration.

9. The computerized printing system according to claim 1, wherein the windows within a particular frame are separated with separation bars having at least two differing widths.

10. The computerized printing system according to claim 1, wherein the graphical user interface further comprises a pointer, and a menu line area, the graphical user interface configured to display menu lines only when the pointer is placed in the menu line area.

11. The computerized printing system according to claim 1, wherein the data units comprise XML data files.

12. The computerized printing system according to claim 1, wherein the windows are separated from each with separation bars, the graphical user interface further comprising icons, adjacent to one or more of the separation bars, configured to provide access to specific functions of the application programs of two adjacent windows.

13. The computerized printing system according to claim 1, wherein the workspace is configured to display return values of the activated application programs.

14. A method for operating a computerized printing system with a data processor which is connected at least to one printer, comprising:
providing a variety of application programs for the system;
accessing a data unit which is a workspace;
opening a frame in a graphical user interface of the system;
accessing all application programs referenced by the workspace; and
assigning these application programs to a particular window in the frame of the graphical user interface.

15. The method according to claim 14, further comprising:
closing a workspace which thereby closes all programs referred to by this particular workspace.

16. The method according to claim 14, further comprising:
reading a list including the references to the application programs upon accessing one or more application programs; and
accessing and assigning the application programs to a specific window, depending on the reading of the references.

17. The method according to claim 16, wherein the references read from the list are names of the application programs.

18. A software product comprising program code configured to be loaded on a data processor of a computer connected to a printing system, and which contains instructions for executing the method according to claim 14.

19. The software products according to claim 18, that comprises at least one data unit.

20. The software products according to claim 19, wherein the data unit comprises an XML data file.
